(19) United States
(12) Patent Application Publication
(10) Pub. No.: US 2006/0103631 A1
(43) Pub. Date: May 18, 2006

(54) Electronic device and pointing representation displaying method

(75) Inventors: Hiroshi Mashima, Osaka (JP); Takae Yasuda, Osaka (JP); Fumiaki Ishito, Osaka (JP)

Correspondence Address: BRINKS HOFER GILSON & LIONE, P.O. BOX 10395, CHICAGO, IL, 60610, US

(73) Assignee: KONICA MINOLTA PHOTO IMAGING, INC.

(21) Appl. No.: 11/249,994

(22) Filed: Oct. 13, 2005

(30) Foreign Application Priority Data
Nov. 18, 2004 (JP) 2004-333957

(51) Int. Cl. G09G 5/08

(52) U.S. Cl. 345/158

(57) ABSTRACT

An electronic device has a display capable of displaying a pointing representation, a detector for detecting a movement of the electronic device, and a display controller for controlling the display so as to move the pointing representation displayed on the display in response to the movement of the electronic device detected by the detector. The pointing representation can be moved by a simplified operation or by moving the electronic device, which consequently reduces the number of operation parts.

This application is based on Japanese Patent Application No. 2004-333957 filed on Nov. 18, 2004, the contents of which are hereby incorporated by reference.

### BACKGROUND OF THE INVENTION

1. Field of the Invention

The present invention relates to an electronic device having an image display section, and more particularly to a method for displaying a movable pointing representation on the image display section.

2. Description of the Related Art

In the technical field of electronic devices such as mobile phones, there is widely known an arrangement in which objects such as characters, symbols, and menus are displayed on a display of the electronic device in a matrix, and a user can select a desired object among the displayed objects, with use of an operating member 100 such as an arrow key indicating four directions (leftward, rightward, upward, and downward directions), or a cross key, as shown in FIG. 12. The operating member 100 is provided separately from keys for entering phone numbers or characters. As shown in FIG. 12, the operating member 100 has an annular portion with plural pressing parts (parts shown by triangular marks in FIG. 12) which are arranged circumferentially spaced apart from each other at a predetermined interval. Judgment as to whether the pressing part has been pressed is made by an illustrated switch provided in correspondence to each of the pressing parts. A user can move the cursor CSL displayed on the display onto a desired object by pressing the respective pressing parts a predetermined number of times.

In the above-mentioned structures, as the number of objects or items to be set such as characters, symbols, and menus is increased, the operation of the operating member 100 becomes cumbersome. Increasing the number of operating members in an attempt to avoid such cumbersome operation of the operating member 100 may increase the production cost because of the newly provided operating members. Further, miniaturization is required in electronic devices having portability such as mobile phones. Increasing the number of operating members may increase the size of such electronic devices.

### SUMMARY OF THE INVENTION

It is an object of the present invention to provide a pointing representation display technology which has overcome the problems residing in the prior art.

It is another object of the present invention to provide an electronic device and a pointing representation display method which have improved operability even if the number of items is increased, with less or no production cost rise and size increase.

According to an aspect of the present invention, a movement of an electronic device having a display is detected to thereby move a pointing representation displayed on the display in response to a detected movement of the electronic device.

The pointing representation is moved relative to the image displayed on the display in response to the movement of the electronic device detected by the detector. Accordingly, the pointing representation can be easily moved or shifted to a desired position on the display by controlledly moving the electronic device.

These and other objects, features and advantages of the present invention will become more apparent upon reading of the following detailed description along with the accompanying drawings.

### BRIEF DESCRIPTION OF THE DRAWINGS

FIG. 1 is a perspective view showing an external appearance of a mobile phone embodying the present invention.

FIG. 2 is a block diagram showing an electrical configuration of the mobile phone.

FIG. 3 is an illustration explaining how the display position of a cursor is changed by a display controller in response to a movement of the mobile phone.

FIG. 4 is a flowchart showing a procedure selection to be implemented by the mobile phone.

FIGS. 5A and 5B are illustrations explaining how the display position of the cursor is changed in response to a movement of the mobile phone.

FIG. 6 is an illustration explaining how the display position of the cursor is changed by the display controller in response to a movement of the mobile phone in the case where the cursor is moved depending on the acceleration of the mobile phone.

FIG. 7 is a front view showing an external appearance of a digital camera embodying the present invention.

FIG. 8 is a rear view of the digital camera.

FIG. 9 is a block diagram showing an electrical configuration of the digital camera.

FIGS. 10A and 10B are illustrations each showing an exemplary frame having a cursor being displayed.

FIGS. 11A and 11B are a flowchart showing a procedure of focusing an object in connection with the frame shown in FIG. 10A, and a flowchart showing a procedure of selecting a desired job item in connection with the frame shown in FIG. 10B.

FIG. 12 is an illustration showing an external appearance of a conventional mobile phone.

### DETAILED DESCRIPION OF THE PREFERRED EMBODIMENTS OF THE INVENTION

### First Embodiment

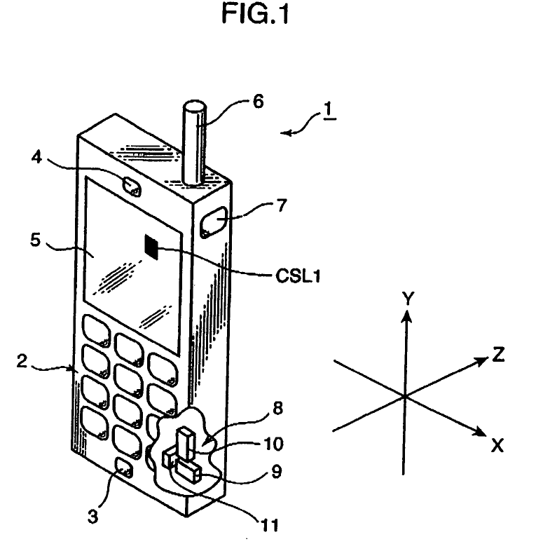

Referring to FIG. 1, a mobile phone 1 is designed for allowing a person holding the mobile phone 1 to communicate with another person holding another mobile phone (not shown) through a radio phone line. The mobile phone 1 includes an operating key section 2, an audio input section 3, an audio output section 4, an image display section 5, an antenna 6, a execution key 7, and a movement detecting section 8. In FIG. 1, the mobile phone 1 is partly broken away in order to show the movement detecting section 8 which is provided inside the mobile phone 1.

The operating key section 2 comprises push keys arranged in a matrix, wherein a digit or a predetermined function is assigned to each of the keys, so that a user can input a phone number or various commands.

The audio input section 3 is adapted to input voice of the user of the mobile phone 1 or the like, and includes a microphone for converting a sound to an electrical signal, for instance.

The audio output section 4 is adapted to output a sound or the like that has been transmitted from another communications device, and includes a speaker for converting an electrical signal to a sound, for instance.

The image display section 5 includes a liquid crystal display (LCD), for example, and is adapted to display a phone number entered through push keys, or various setting pages. The image display section 5 may include an organic electroluminescence (EL) display or a plasma display. FIG. 1 shows a state that a cursor or pointing representation CSL1 is displayed on a screen of the image display section 5.

The antenna 6 is adapted to send and receive radio waves for communication with another communications device through a base station.

The execution key 7 is adapted to enter determination of a designated item among the plural items on the various setting pages displayed on the screen of the image display section 5.

The movement detecting section 8 is adapted to detect a movement of the mobile phone 1. Assuming a three-dimensional coordinate system, wherein X-axis denotes a width direction of the mobile phone 1, Y-axis denotes a longitudinal direction of the mobile phone 1, and Z-axis denotes a thickness direction of the mobile phone 1 shown in FIG. 1, the movement detecting section 8 is constituted of an X sensor 9 for detecting a movement of the mobile phone 1 in the X-axis direction, a Y sensor 10 for detecting a movement of the mobile phone 1 in the Y-axis direction, and a Z sensor 11 for detecting a movement of the mobile phone 1 in the Z-axis direction. The X sensor 9, the Y sensor 10, and the Z sensor 11 are each constituted of a gyro sensor incorporated with a piezoelectric device, for instance, for detecting angular velocities of the mobile phone 1 in the X-axis, Y-axis, and Z-axis directions, respectively.

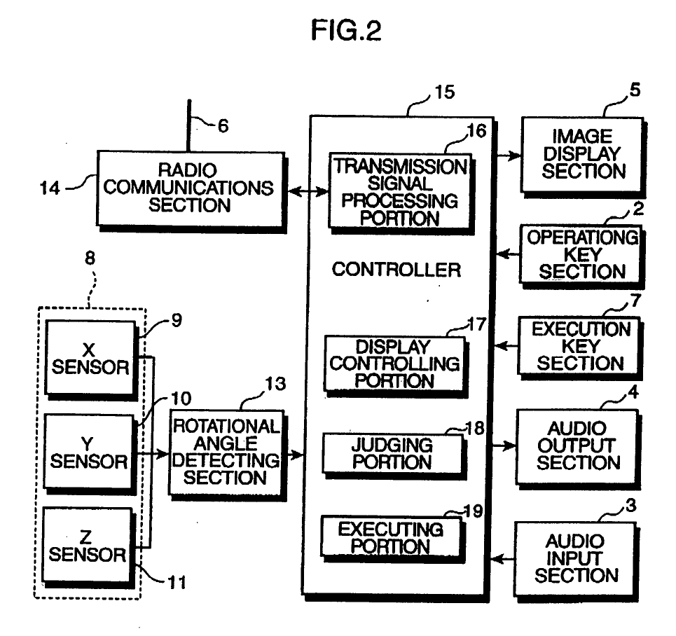

As shown in FIG. 2, the mobile phone 1 is further provided with a rotational angle detecting section 13, a radio communications section 14, and a controller 15.

The rotational angle detecting section 13 includes a filter circuit (low-pass filter and high-pass filter) for reducing a noise and a drift from angular velocity signals outputted from the X sensor 9, the Y sensor 10, and the Z sensor 11, respectively, and an amplification circuit for amplifying the respective angular velocity signals.

The radio communications section 14 includes a duplexer, a low noise amplifier (LNA), a surface acoustic wave (SAW) filter, a phase locked loop (PLL) frequency synthesizer, an MIX, a modem, an audio coder/decoder, and a power amplifier (PA). The radio communications section 14 is adapted to communicate data such as audio data and image data between the mobile phone 1 and another mobile phone via an unillustrated communications network and the antenna 6 at predetermined receiving and transmitting frequencies.

The controller 15 includes a microcomputer serving as a central processor, an ROM for storing a control program, and an RAM for temporarily storing data to provide a transmission signal processing portion 16, a display controlling portion 17, a judging portion 18, and an executing portion 19. The controller 15 controls operations of the respective parts of the mobile phone 1.

The transmission signal processing portion 16 is adapted to apply a predetermined procedure to data received by the radio communications section 14, or data to be outputted to the radio communications section 14. For instance, the transmission signal processing portion 16 expands data received by the radio communications section 14, or compresses data to be outputted to the radio communications section 14.

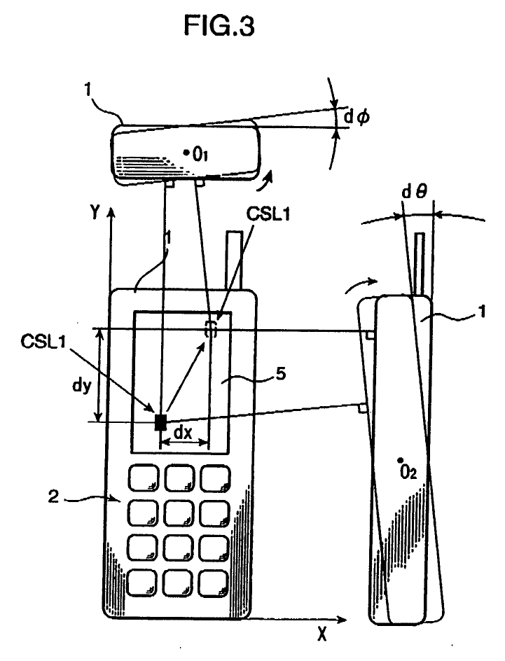

The display controlling portion 17 controls the image display section 5 to change the display position of the cursor CSL1, namely, moves the cursor CSL1 based on a detection signal sent from the movement detecting section 8. Referring to FIG. 3, a relationship between the movement of the mobile phone 1 and the movement of the cursor CSL1 on the display section 5 will be described. The X-axis and the Y-axis in FIG. 3 correspond to the X-axis and the Y-axis in FIG. 1, respectively.

The display controlling portion 17 controls the image display section 5 to move the cursor CSL1 in the X-axis direction relative to the image displayed on the screen of the image display section 5 by pivotally rotating or swinging the mobile phone 1 about the Y-axis or an axis parallel to the Y-axis. Specifically, as shown in FIG. 3, when the mobile phone 1 is pivotally rotated or swung counterclockwise about a longitudinal axis O₁ of rotation in the top plan view, which passes a center on the top wall of the mobile phone 1, the display controlling portion 17 controls the image display section 5 to move the cursor CSL1 rightward along the X-axis. On the other hand, when the mobile phone 1 is pivotally rotated or swung clockwise about the longitudinal axis O₁ in the top plan view, the display controlling portion 17 controls the image display section 5 to move the cursor CSL1 leftward along the X-axis.

A traveling distance dx of the cursor CSL1 to be displayed on the screen of the image display section 5 is calculated by implementing the following equation (1):
dx=A·dφ (1)
wherein A denotes a constant, and dφ denotes a rotational angle of the mobile phone 1 about the Y-axis or the axis parallel to the Y-axis. The rightward direction along the X-axis in FIG. 3 is the positive direction. In other words, the counterclockwise rotation of the mobile phone 1 about the longitudinal axis O₁ causes the cursor CSL1 to move the positive direction along the X-axis.

Further, the display controlling portion 17 controls the image display section 5 to move the cursor CSL1 in the Y-axis direction when the mobile phone 1 is pivotally rotated or swung about the X-axis or an axis parallel to the X-axis. Specifically, as shown in FIG. 3, when the mobile phone 1 is pivotally rotated counterclockwise about a lateral axis O₂ of rotation in the right side view, which passes a center on a right-side wall of the mobile phone 1, namely, when an upper part of the mobile phone 1 is swung in a forward direction on the plane of FIG. 3, the display controlling portion 17 controls the image display section 5 to move the cursor CSL1 downward along the Y-axis. On the other hand, when the mobile phone 1 is pivotally rotated clockwise about the lateral axis O₂ of rotation in the right side view, namely, when the upper part of the mobile phone 1 is swung in a backward direction on the plane of FIG. 3, the display controlling portion 17 controls the image display section 5 to move the cursor CSL1 upward along the Y-axis.

A traveling distance dy of the cursor CSL1 to be displayed on the screen of the image display section 5 is calculated by implementing the following equation (2):
dy=B·dθ (2)
wherein B denotes a constant, and dφ denotes a rotational angle of the mobile phone 1 about the X-axis or the axis parallel to the X-axis. The upward direction along the Y-axis on the plane of FIG. 3 is positive. In other words, the clockwise rotation of the mobile phone 1 about the longitudinal axis O₂ causes the cursor CSL1 to move the positive direction along the Y-axis.

The constants A and B are values that determine the respective traveling distances of the cursor CSL1 along the X-axis and Y-axis in response to a rotational amount of the mobile phone 1, and are defined considering the operability of the mobile phone 1. Specifically, if the cursor CSL1 is attempted to be moved greatly even though the rotational amount of the mobile phone 1 is relatively small in the case where the number of items to be displayed on the screen of the image display section 5 is relatively large, it is highly likely that the cursor CSL1 may pass over the target position corresponding to a desired item, which makes it difficult to coincide the cursor CSL1 with the target position.

On the other hand, if the cursor CSL1 is attempted to be moved slightly even though the rotational amount of the mobile phone 1 is relatively large in the case where the number of items to be displayed on the screen of the image display section 5 is relatively small, it is required to rotate the mobile phone 1 excessively largely or to rotate the mobile phone 1 many times in order to move the cursor CSL1 to the target position corresponding to a desired item.

In both of the cases, the operability of the mobile phone 1 is lowered. The constants A and B are defined to such values that eliminate or suppress the aforementioned drawbacks. The constants A and B may be fixed irrespective of the kind of pages to be displayed on the screen of the image display section 5. It is, however, preferable to vary the constants A and B depending on the kind of pages to be displayed on the screen of the image display section 5, considering the above drawbacks.

The judging portion 18 judges that the item corresponding to the display position of the cursor CSL1 has been determined in response to depressing of the execution key 7.

The executing portion 19 executes a procedure corresponding to the item when the judging portion 18 judges that the item corresponding to the display position of the cursor CSL1 has been determined.

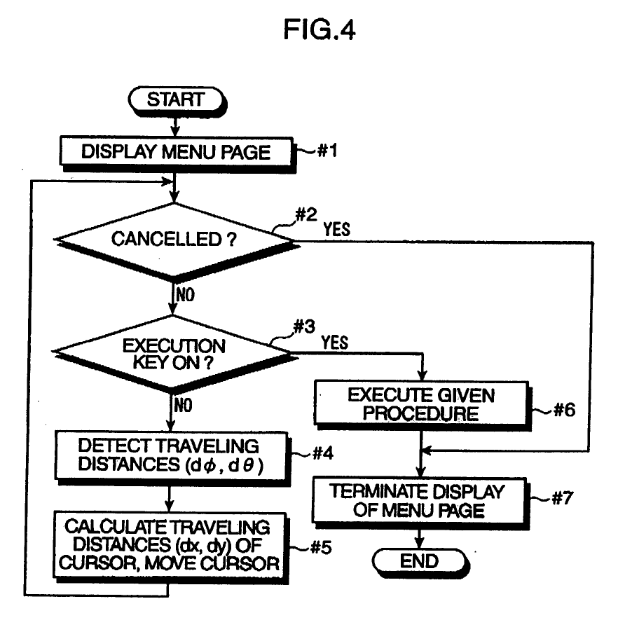

A procedure selection of the mobile phone 1 will be described in accordance with a flowchart shown in FIG. 4.

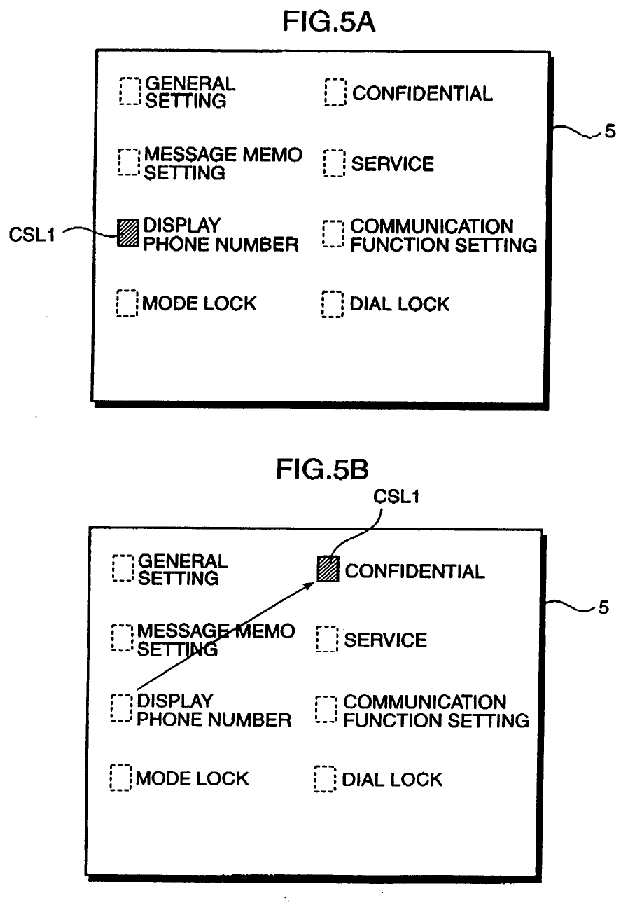

Referring to FIG. 4, when designation to display the menu page shown in FIG. 5 is entered, the controller 15 controls the image display section 5 to display the menu page (Step #1). Then, the controller 15 judges whether cancellation of the menu page display has been commanded (Step #2). If it is judged that the cancellation has been commanded (YES in Step #2), the controller 15 controls the image display section 5 to terminate the menu page display (Step #7). On the other hand, if it is judged that the cancellation has not been commanded (NO in Step #2), the controller 15 judges whether the execution key 7 has been depressed or operated (Step #3).

If the controller 15 judges that the execution key 7 has not been depressed (NO in Step #3), the controller 15 performs detection of a pivotal rotation or a rotary movement of the mobile phone 1 about the X-axis or the axis parallel to the X-axis, or about the Y-axis or the axis parallel to the Y-axis (Step #4), and controls the image display section 5 to move the cursor CSL1 based on the detected rotary movement of the mobile phone 1 (Step #5).

In other words, when the rotational angle of the mobile phone 1 about the Y-axis or the axis parallel to the Y-axis is dφ, and the rotational angle of the mobile phone 1 about the X-axis or the axis parallel to the X-axis is dθ, then, the traveling distances (dx, dy) of the cursor CSL1 along the X-axis and Y-axis are calculated based on the equations (1), (2) to move the cursor CSL1 by the traveling distances (dx, dy).

For instance, as shown in FIG. 5A, let us assume that eight items are displayed on the screen of the image display section 5 in a matrix (four in a column, and two in a row), and the cursor CSL1 is located on the item “phone number display” in the third row of the left column, as shown in FIG. 5A. Then, when the mobile phone 1 is pivotally rotated or swung about the axis O₁ of rotation (see FIG. 3) passing the center on the top wall of the mobile phone 1 counterclockwise as viewed from the top of the mobile phone 1, followed by pivotal rotation or swing of the mobile phone 1 about the axis O₂ of rotation (see FIG. 3) passing the center on the right-side wall of the mobile phone 1 clockwise as viewed from the right side of the mobile phone 1, then, the controller 15 controls the image display section 5 to move the cursor CSL1 to the item “confidential” in the first row of the right column, as shown in FIG. 5B.

The examples in FIGS. 5A and 5B show a case that plural displayable positions of the cursor CSL1 are prepared in a discrete manner in advance, and the cursor CSL1 is moved to an item which is closest to the position moved by the traveling distance (dx, dy).

Returning to FIG. 4, if the controller 15 judges that the execution key 7 has been depressed (YES in Step #3), the controller 15 judges that the item corresponding to the display position of cursor CSL1 has been determined in response to depressing of the execution key 7 (Step #6), and controls the image display section 5 to terminate the display of the menu page (Step #7).

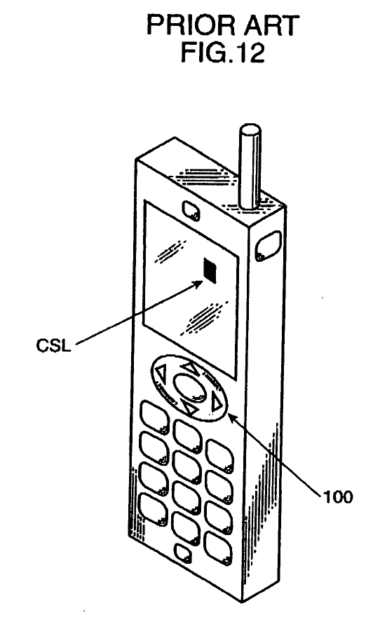

In this way, the cursor CSL1 is movable on the screen of the image display section 5 by pivotally rotating or swinging the mobile phone 1. This arrangement eliminates a cumbersome operation such as manipulating the keys with the thumb of a user's hand while holding the mobile phone 1 with the fingers other than the thumb, for instance. Specifically, it is necessary to depress the rightward arrow key once and the upward key twice with the thumb while holding the mobile phone 1 with the fingers other than the thumb, for example, to change the display state from the state shown in FIG. 5A to the state shown in FIG. 5B, with use of the conventional cross key as shown in FIG. 12. However, in the embodiment, since such a cumbersome operation is not necessary, the operability of the mobile phone 1 can be improved. Further, miniaturization and production cost reduction of the mobile phone 1 can be realized because there is no need of providing keys, switches, or like devices to manipulate movement of the cursor.

In the foregoing embodiment, when the mobile phone 1 is rotated counterclockwise about the longitudinal axis O₁ of rotation passing the center on the top wall of the mobile phone 1 as viewed from the top of the mobile phone 1 on the plane of FIG. 3, the cursor CSL1 is moved rightward along the X-axis on the screen of the image display section 5, and when the mobile phone 1 is rotated clockwise, the cursor CSL1 is moved leftward along the X-axis. Alternatively, the mobile phone 1 may be operated in a manner opposite to the above.

Specifically, it is possible to construct the mobile phone 1 in such a manner that the cursor CSL1 moves leftward along the X-axis on the screen of the image display section 5 by rotating the mobile phone 1 counterclockwise, and the cursor CSL1 moves rightward along the X-axis by rotating the mobile phone 1 clockwise.

In the foregoing embodiment, when the mobile phone 1 is rotated counterclockwise about the lateral axis O₂ of rotation passing the center on the right-side wall of the mobile phone 1, as viewed from the right side of the mobile phone 1 on the plane of FIG. 3, the cursor CSL1 is moved downward along the Y-axis on the screen of the image display section 5, and when the mobile phone 1 is rotated clockwise, the cursor CSL1 is moved upward along the Y-axis. Alternatively, the mobile phone 1 may be operated in a manner opposite to the above. Specifically, it is possible to construct the mobile phone 1 in such a manner that the cursor CSL1 moves upward along the Y-axis on the screen of the image display section 5 by rotating the mobile phone 1 counterclockwise, and the cursor CSL1 moves downward along the Y-axis by rotating the mobile phone 1 clockwise.

In the foregoing embodiment, the angular velocities of the mobile phone 1 in the X-, Y-, and Z-axis directions are detected, and the cursor CSL1 is moved depending on the detected angular velocities. Alternatively, a movement detecting section is constructed by a plurality of acceleration sensors for detecting accelerations of a mobile phone 1 in the X-, Y-, and Z-axis directions shown in FIG. 1, and to move a cursor CSL1 depending on the accelerations detected by the respective acceleration sensors.

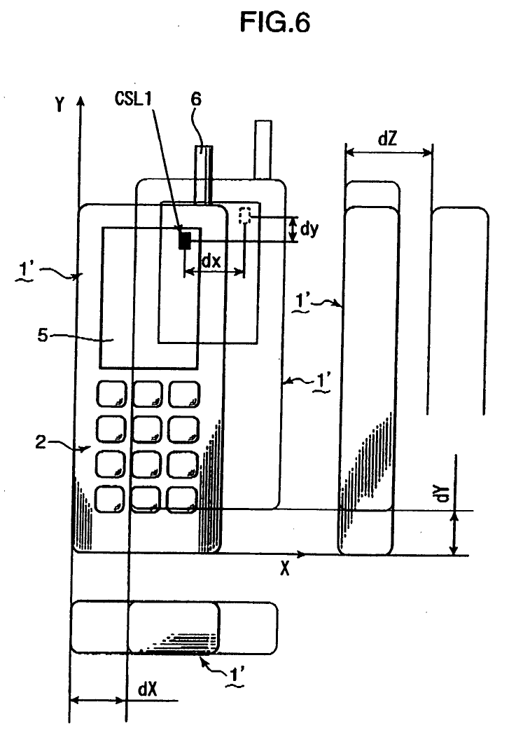

Referring to FIG. 6, a modified mobile phone provided with a movement detecting section including a plurality of acceleration sensors will be described. The modified mobile phone has an electrical configuration which is substantially the same as the foregoing embodiment except for the movement detecting section including a plurality of acceleration sensors in place of angular velocity sensors, and non-provision of the execution key.

As shown in FIG. 6, when the mobile phone 1 is moved in one of the two opposite directions along the X-axis, the display controlling portion 17 controls the display image section 5 to move the cursor CSL1 in the other one of the two opposite directions relative to the image displayed on the screen of the image display section 5. For instance, when the mobile phone 1 is moved rightward along the X-axis on the plane of FIG. 6, the display controlling portion 17 controls the image display section 5 to move the cursor CSL1 leftward along the X-axis. On the other hand, when the mobile phone 1 is moved leftward along the X-axis, the display controlling portion 17 controls the image display section 5 to move the cursor CSL1 rightward along the X-axis.

A traveling distance dx of the cursor CSL1 along the X-axis is calculated by implementing the following equation (3):
dx=C·dX (3)
wherein C denotes a constant, and dX denotes a traveling distance of the mobile phone 1 along the X-axis. The rightward direction on the plane of FIG. 6 is positive.

Further, when the mobile phone 1 is moved in one of the two opposite directions along the Y-axis on the plane of FIG. 6, the display controlling portion 17 controls the image display section 5 to move the cursor CSL1 in the other one of the two directions relative to the image displayed on the screen of the image display section 5. For instance, when the mobile phone 1 is moved upward along the Y-axis on the plane of FIG. 6, the display controlling portion 17 controls the image display section 5 to move the cursor CSL1 downward along the Y-axis. On the other hand, when the mobile phone 1 is moved downward along the Y-axis, the display controlling portion 17 controls the image display section 5 to move the cursor CSL1 upward along the Y-axis.

A traveling distance dy of the cursor CSL1 along the Y-axis is calculated by implementing the following equation (4):
dy=D·dY (4)
wherein D denotes a constant, and dY denotes a traveling distance of the mobile phone 1 along the Y-axis. The rightward direction on the plane of FIG. 6 is positive.

A judging portion 18 judges that the item at the cursor CSL1 has been selected in response to generation of an acceleration in the mobile phone 1 in a direction oriented backward of the mobile phone 1 along the Z-axis (direction normal to the displaying surface of the mobile phone 1), namely, in response to backward movement of the mobile phone 1. It is preferable to set a threshold of the acceleration as a judgment criterion, so that the judgment may not be made based on an insignificant movement of the mobile phone 1.

An executing portion 19 executes a procedure corresponding to the designated item in response to a judgment of the judging portion 18 that the item at the cursor CSL1 has been selected.

The operation flow to be implemented by the mobile phone 1 in the modification is substantially the same as that in the first embodiment except for the following. In the operations of the modification corresponding to the operations of Steps #4 and #5 of the flowchart shown in FIG. 4, the movement of the mobile phone 1 is detected based on detection signals outputted from the acceleration sensors to move the cursor CSL1 depending on the detected movement, in place of detection signals outputted from the angular velocity sensors, and in the operation corresponding to the operation of Step #6, the determination of the designated item is performed based on the judgment as to whether the mobile phone 1 has been moved backward along the Z-axis at Step #3, in place of the judgment as to whether the execution key 7 has been depressed.

As described above, in the modification, the cursor CSL1 is movable on the screen of the image display section 5 in response to a movement of the mobile phone 1. Accordingly, the operability of the mobile phone 1 can be improved in a similar manner as in the foregoing embodiment. Particularly, in the modification, since the judgment as to whether the designated item has been determined is made based on the judgment whether the mobile phone 1 has been moved backward along the Z-axis, the modification provides superior operability to the foregoing embodiment. Furthermore, the modification contributes to further miniaturization and production cost reduction of the mobile phone 1, as compared with the foregoing embodiment, because the execution key 7 is not necessary in the modification.

In the foregoing modification, the display controlling portion 17 controls the image display section 5 to move the cursor CSL1 leftward along the X-axis in response to a rightward movement of the mobile phone 1 along the X-axis and move the cursor CSL1 downward along the Y-axis in response to an upward movement of the mobile phone 1 along the Y-axis, and controls the image display section 5 to move the cursor CSL1 rightward along the X-axis in response to a leftward movement of the mobile phone 1 along the X-axis and move the cursor CSL1 upward along the Y-axis in response to a downward movement of the mobile phone 1 along the Y-axis. Alternatively, the mobile phone 1 may be operated in a manner opposite to the above.

Specifically, it may be appreciated to construct the mobile phone 1 in such a manner that the display controlling portion 17 controls the image display section 5 to move the cursor CSL1 rightward along the X-axis in response to a rightward movement of the mobile phone 1 along the X-axis and move the cursor CSL1 upward along the Y-axis in response to an upward movement of the mobile phone 1 along the Y-axis, and controls the image display section 5 to move the cursor CSL1 leftward along the X-axis in response to a leftward movement of the mobile phone 1 along the X-axis and move the cursor CSL1 downward along the Y-axis in response to a downward movement of the mobile phone 1 along the Y-axis.

### Second Embodiment

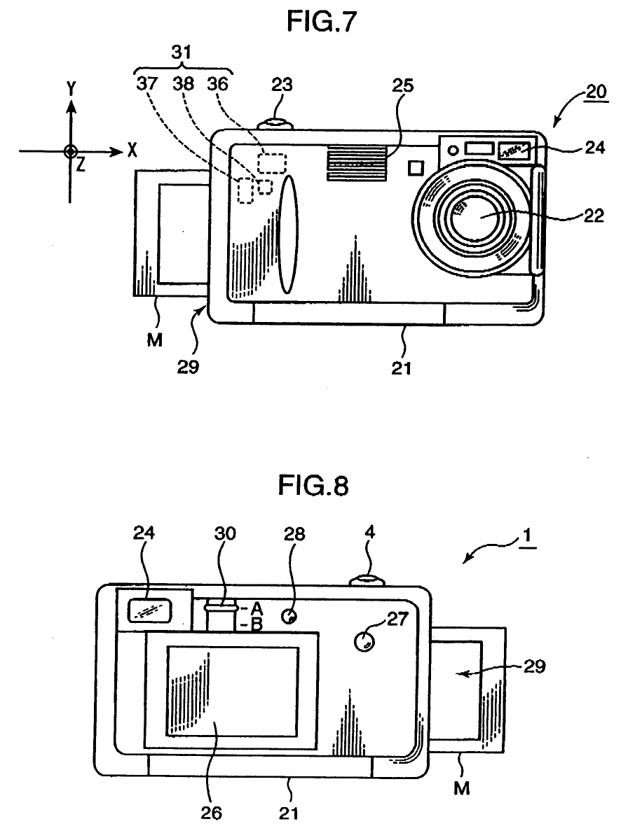

Referring to FIGS. 7 to 9, a digital camera 20 includes a camera body 21, a photographic optical system 22, a shutter start button 23, an optical viewfinder 24, an electronic flash 25, a liquid crystal display (LCD) 26, an function key 27, a power key 28, a card slot 29, a mode setting switch 30, and a movement detecting section 31.

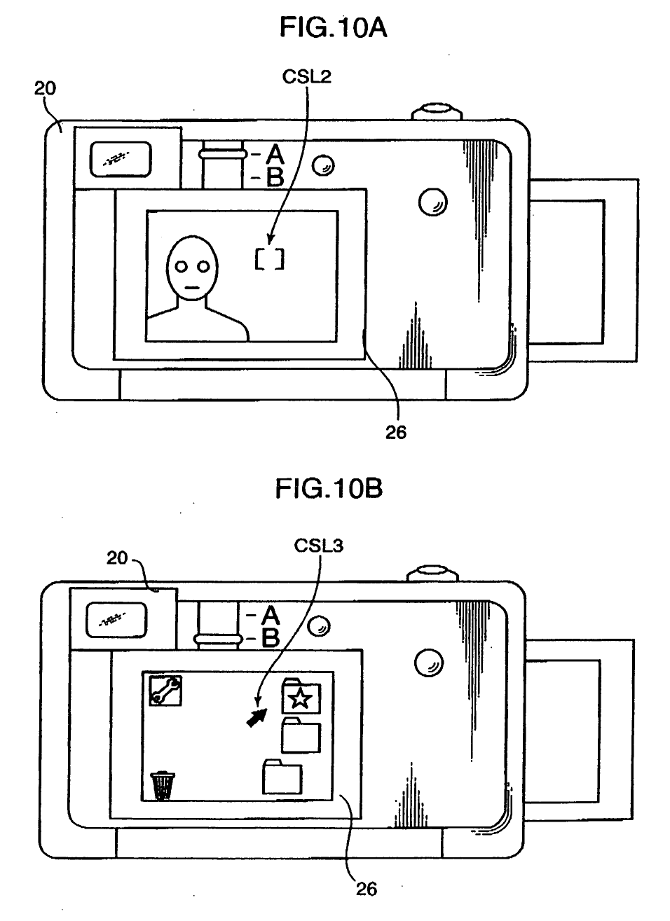

As shown in FIG. 7, the photographic optical system 22 is arranged on the right side on a front face of the camera body 21 for taking a light image of an object. The photographic optical system 22 has a zoom lens unit 32 (see FIG. 9), and a focus lens unit 33 (see FIG. 9) for focus length change or focusing adjustment.

The shutter start button 23 is a two-stage operable key constructed such that the key is halfway depressed and fully depressed. The shutter start button 23 is adapted to designate a timing of exposure by an image sensor 34 (see FIG. 9), which will be described later. When the shutter start button 23 is halfway depressed, the digital camera 20 is brought to a photography preparation state where exposure values such as a shutter speed and an aperture value are set. When the shutter start button 23 is fully depressed, an exposure to the image sensor 34 is started to generate object image data to be recorded in an image storage 35 (see FIG. 9), which will be described later.

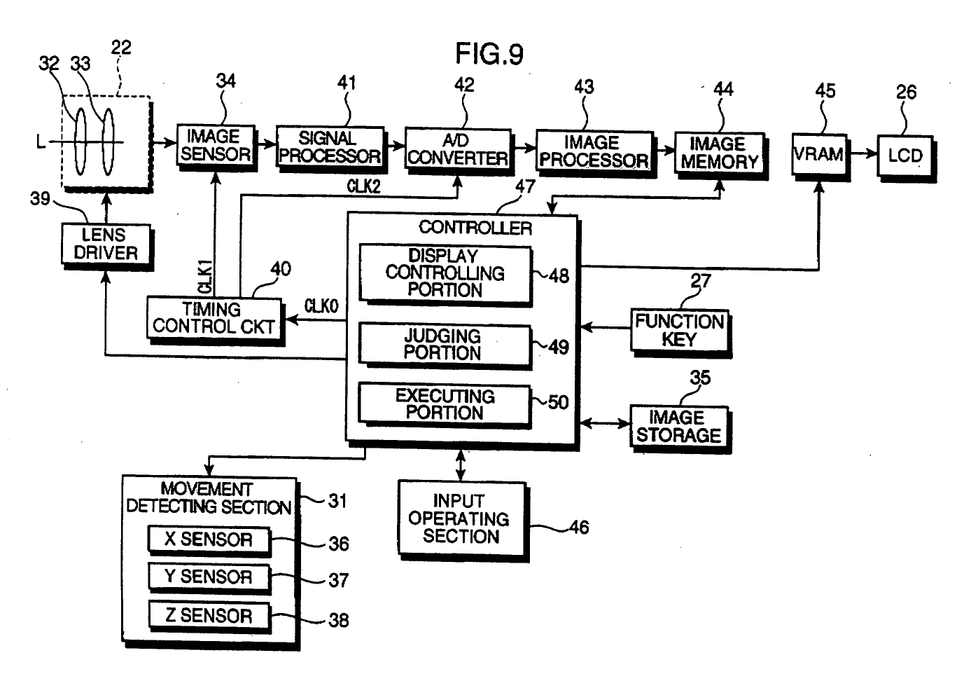

As shown in FIG. 8, the optical viewfinder 24 is provided on an upper left portion on a rear face of the camera body 21 for optically indicating an area within which the object image is to be photographed.

The built-in electronic flash 25 is arranged on an upper middle part on the front face of the camera body 21 for irradiating illumination light onto the object by discharging an unillustrated discharge lamp in the case where the light intensity from the object is insufficient.

The LCD 26 is arranged substantially in the middle on the rear face of the camera body 21. The LCD 26 includes a color LCD panel, and is adapted to display an image captured by the image sensor 34 or a recorded image for playback, as well as displaying a setting frame page indicating functions or modes provided in the digital camera 20. It may be possible to provide an organic EL display or a plasma display, in place of the LCD 26.

The function key 27 is arranged at an appropriate position on the right side of the LCD 26 for driving the photographic optical system 22 in a wide angle or telephoto direction, and for switching the photography mode between still image photography and motion image photography. Further, the function key 27 is operated to determine the execution of a given operation procedure as described below.

The power key 28 is arranged at an upper rear part of the camera body 21, on the left side of the function key 27, as shown in FIG. 8. The main power of the digital camera 20 is alternately turned on and off each time the power key 28 is depressed.

The card slot 29 is formed in a side wall of the camera body 21, so that a memory card M consisting of plural semiconductor memory devices is mountable.

The mode setting switch 30 is arranged on the upper rear part of the camera body 21, and is comprised of a slide switch having two contacts which slides up and down. Specifically, as shown in FIG. 8, when the mode setting switch 30 is set to the position A, the digital camera 20 is brought to the photography mode where an object image is photographed, and when the mode setting switch 30 is set to the position B, the digital camera 20 is brought to the playback mode where the photographed image recorded in the memory card M is displayed on the LCD 26 for playback.

The movement detecting section 31 is adapted to detect a movement of the digital camera 20. Assuming that a horizontal direction on the plane of FIG. 7 is X-axis direction, a direction perpendicular to the X-axis direction is Y-axis direction, and a direction perpendicular to the X-axis and the Y-axis directions is Z-axis direction, the movement detecting section 31 is constituted of an X sensor 36 for detecting a movement of the camera 20 along the X-axis, a Y sensor 37 for detecting a movement of the camera 20 along the Y-axis, and a Z sensor 38 for detecting a movement of the camera 20 along the Z-axis. The X sensor 36, the Y sensor 37, and the Z sensor 38 are each constituted of a gyro sensor incorporated with a piezoelectric device, for instance, for detecting angular velocities of a shake of the camera 20 in the X-, Y-, and Z-axis directions, respectively. The movement detecting section 31 may be constituted of the aforementioned acceleration sensors.

Now, an electrical configuration of the digital camera 20 is described referring to FIG. 9. The digital camera 20 is further provided with a lens driver 39 including a motor for driving the zoom lens unit 32 and the focus lens unit 33 of the photographic optical system 22. As the image sensor 34, for instance, is used a CCD color area sensor comprising pixels arrayed in a matrix for receiving light of respective color components of red (R), green (G), and blue (B). The image sensor 34 is adapted to photoelectrically convert an object light image formed on the image sensing plane of the image sensor 34 by the photographic optical system 22 into image signals of the respective color components of R, G, B for outputting.

A timing controlling circuit 40 is controlled by a controller 47, which will be described later. The timing controlling circuit 40 generates a clock signal CLK1 such as a signal for controlling driving of the image sensor 34, e.g., a timing signal for exposure start/end (integration start/end), and a readout control signal of reading out light receiving signals on the respective pixels including a horizontal synchronizing signal, a vertical synchronizing signal, and a transfer signal, based on a reference clock CLK0, and outputs a clock signal CLK1 to the image sensor 34. Further, the timing controlling circuit 40 generates a clock CLK2 for analog-to-digital conversion based on the reference clock CLK0, and outputs the clock CLK2 to an analog-to-digital (A/D) converter 42.

A signal processor 41 applies a predetermined analog signal processing to the image signal (analog signal) outputted from the image sensor 34. Specifically, the signal processor 41 removes noises from the analog image signal outputted from the image sensor 34, and adjusts the level of the image signal.

The A/D converter 42 converts the respective analog pixel signals of image data outputted from the signal processor 41 to digital signals of a predetermined bit, e.g., 10 bits, based on the clock CLK2 outputted from the timing controlling circuit 40.

An image processor 43 implements black level correction of correcting the black level of the pixel signal (hereinafter, called as “pixel data”) which has been analog-to-digital converted by the A/D converter 42 to a reference black level, white balance correction of adjusting the level of the pixel data of the respective color components of R, G, B, and gamma correction of correcting gamma characteristics of the pixel data.

An image memory 44 is a memory for temporarily storing the pixel data outputted from the image processor 43 while the camera 20 is in the photography mode, and is used as a work area within which the controller 47 performs a predetermined procedure with respect to the image data. The image memory 44 also serves as a memory for temporarily storing the image data read out from the image storage 35 while the camera 20 is in the playback mode.

A VRAM 45 is a buffer memory for storing image data, so that an image is displayed on the LCD 26 for playback, and has a recording capacity capable of storing image data corresponding to the pixels of the LCD 26.

The image storage 35 includes the memory card M and a hard disk, and is adapted to store the image data generated by control operation of the controller 47.

An input operating section 46 is adapted to enter information relating to manipulation of the shutter start button 23, the mode setting switch 30, or the like device to the controller 47.

The controller 47 has a microcomputer and is adapted to control overall photographing operation of the digital camera 20 by controlling operations of the respective parts in the camera body 21. The controller 47 has an RAM serving as a work area for a central processing, and an ROM for storing programs to execute various functions provided in the digital camera 20. The controller 47 is provided with a display controlling portion 48, a judging portion 49, and an executing portion 50.

The display controlling portion 48 changes the position of a cursor on various pages based on a detection signal sent from the movement detecting section 31. A moving direction and moving distance of the cursor are calculated in the same way as those described with reference to the mobile phone shown in FIGS. 1 to 3.

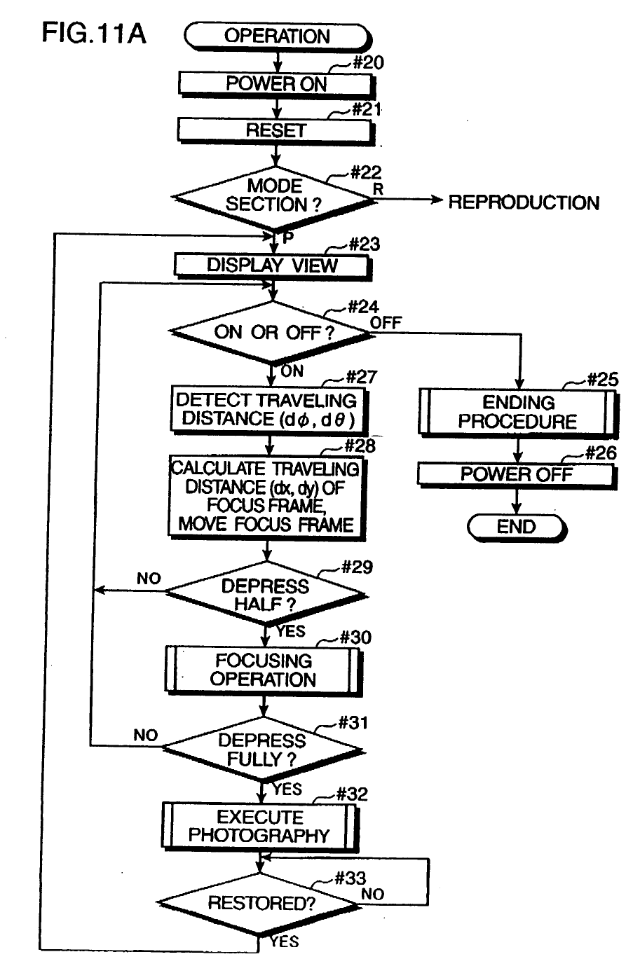

FIGS. 10A and 10B show exemplary display patterns having a cursor. In FIG. 10A, an object image to be recorded and a cursor CSL2, that is, a focus frame for indicating an area to be in focus, are displayed on the display screen, the cursor CSL2 being defined by a pair of brackets. In FIG. 10B, there are on the display screen five job items or icons, such as folder icons indicating storage of image data in the image storage 35, a tool icon having a wrench figure for allowing a user to set a desired function in the digital camera 20, a tool icon having a trash box figure for allowing the user to remove an image, and a cursor CSL3 in the form of an arrow. These icons or job items are arranged in the free way. The cursor CSL2 (CSL3) is moved a calculated distance in a calculated direction in accordance with a movement of the digital camera 20, similarly to the foregoing embodiment and modifications.

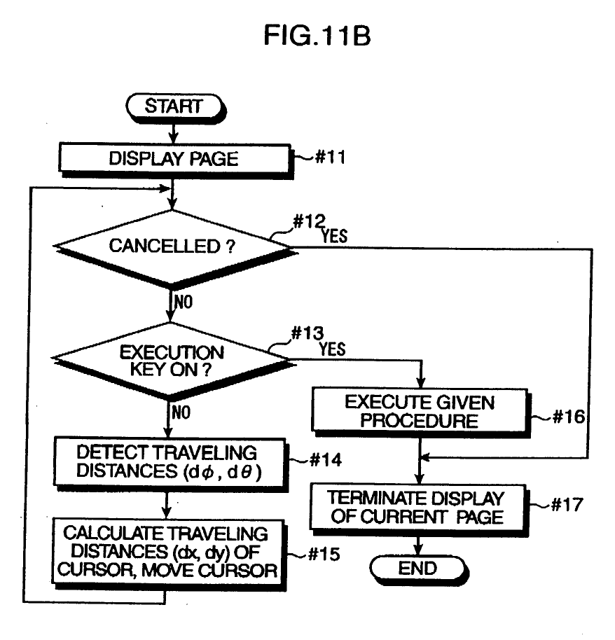

Referring to FIG. 11A showing a photographing or image recording procedure to be executed by the digital camera shown in FIG. 10A, specifically, the power key 28 is turned on (Step #20) and the digital camera 20 is then reset to the initial operation settings (Step #21). In Step #22, it is judged based on the position of the mode setting switch 30 which of the reproduction mode and the photography mode is selected or set. If the reproduction mode is judged to be set, the controller 47 advances this flow to the reproduction mode. However, the detailed steps of the reproduction mode are omitted to simplify the description of the embodiment.

In the case where the photography mode is judged to be set, a live view which is being taken through the optical system 22 is displayed on the display 26 (Step #23). In Step #24, it is judged whether the power key 28 is not turned off. If the power key 28 is turned off, this flow advances to Step #25 where the ending procedure is performed, and the digital camera 20 is completely put in the Off-state (Step #26).

In the case where the digital camera 20 is judged to be in the On-state (ON in Step #24), the controller 47 performs detection of movements of the digital camera 20 about the X-axis or the axis parallel to the X-axis, or about the Y-axis or the axis parallel to the Y-axis (Step #27), and moves the focus frame or cursor CSL2 based on the detected rotary movement of the digital camera 20 (Step #28).

Subsequently, in Step #29, it is judged whether the shutter start button 23 is depressed halfway. If the shutter start button 23 is depressed halfway, the focusing operation is carried out to focus on an object falling within the moved focus frame CSL2 (Step #30). Thereafter, it is judged in Step #31 whether the shutter start button 23 is depressed fully. The photography is executed in Step #32 if the shutter start button 23 is judged to be depressed fully (YES in Step #31). If the shutter start button 23 is not depressed halfway (NO in Step #29) or is not depressed fully (NO in Step #31), this flow returns to Step #24.

After the photography is executed, it is judged in Step #33 whether the shutter start button 23 is restored to the original position. This judgment is performed to determine whether to restart the display of a live view and a new photographing operation. During the period that the shutter start button 23 is kept in the halfway-depression state (NO in Step #33), the camera operation is prevented from advancing. When the shutter start button 23 is restored to the original position (YES in Step #33), this flow returns to Step #23.

Referring to FIG. 11B showing a procedure of selecting a desired job among a number of jobs executed by the digital camera, when designation to display the menu page shown in FIG. 10B is entered, the controller 47 sends the necessary image data to the VRAM 45 to display a certain page (Step #11). Then, the controller 47 judges whether cancellation of the certain page display has been commanded (Step #12). If it is judged that the cancellation has been commanded (YES in Step #12), the controller 47 terminates the current page display (Step #17). On the other hand, if it is judged that the cancellation has not been commanded (NO in Step #12), the controller 47 judges whether the determination has been made by operating the function key 27 (Step #13).

If the function key 27 is judged not to be operated (NO in Step #13), the controller 47 performs detection of movements of the digital camera 20 about the X-axis or the axis parallel to the X-axis, or about the Y-axis or the axis parallel to the Y-axis (Step #14), and moves the cursor CSL3 based on the detected rotary movement of the digital camera 20 (Step #15). If the function key 27 is judged to be operated (YES in Step #13), the controller 47 judges that a job item corresponding to the display position of cursor CSL3 has been determined by the operation of the function key 27 (Step #16), and terminates the display of the current page (Step #17).

As described above, the digital camera 20 is constructed such that the cursor CSL2 (CSL3) is movable on the LCD 26 in response to a movement of the digital camera 20, namely, by applying a movement to the digital camera 20. Similarly to the foregoing embodiment, this embodiment is advantageous in improving the operability of the digital camera 20 and in miniaturization and production cost reduction of the digital camera 20 because there is no need of providing keys or switches for designating movement of the cursor CSL2 (CSL3).

Moreover, it may be appreciated to utilize the X sensor 36, Y sensor 37, and Z senor 38 as shake detection sensors to correct the shake of the camera body to secure photographing operation without image blur arising from shake of the camera or the like in hand-held photographing, telephotographing, or photographing in a dark place where a long-time exposure is required. The shake correcting function is to correct misalignment of an optical axis L of the digital camera 20 by oscillating a shake correction optical system or an image sensor to cancel a shake of the camera in the case where misalignment of the optical axis L occurs due to the shake of the camera or the like.

In the conventional camera provided with the shake correction function, the sensors 36 to 38 are not utilized for the movement detection to move the cursor CSL2 (CSL3) in the course of the series of image taking procedures for image recording, but are utilized for the movement detection to correct image shake. However, the sensors 36 to 38 can be utilized for the movement detection to move the cursor CSL2 (CSL3) before the series of image taking procedures for image recording is started by the full depression of the shutter start button 23 or after the image taking procedures are completed. The utilization of the sensors 36 to 38 to move the cursor CSL2 (CSL3) eliminates the need of providing another sensors for the movement of the cursors, and thus suppresses the cost rise.

The items to be selected by the cursor may be aligned in a row, arrayed along a curve, or arranged at random, in place of the matrix arrangement as shown in FIG. 5.

In the embodiment of the mobile phone, the moving distance of the cursor is set larger or smaller than an actual movement of the mobile phone, namely, the sensitivity of the cursor is set at a high or low level, in consideration of the operability of the mobile phone 1. Alternatively, it may be possible to move the cursor by the same amount as the moving distance of the mobile phone 1, or to move the cursor by a predetermined amount in response to one turn or a movement of the mobile phone 1, irrespective of the rotational amount or the moving distance of the mobile phone 1, in such a manner that the moving distance of the cursor is increased proportional to the number of turns or movements of the mobile phone 1.

The term “pointing representation” throughout the specification and claims is not limited to the one which is provided separately from the item, such as the cursor as represented in the form of a solid square (see FIGS. 1, 3, and 5) or the pointer as represented in the form of an arrow (see FIG. 10B), but includes the one which is displayed integrally with the item by highlight display or in a color different from the color of the item. Further, the term “pointing representation” is not limited to the one for selecting the item, but includes the one for designating a specific image or an image area within an entire image displayed on the screen of the image display section.

A display technology such as scroll display or page changeover display may be combinedly used in these embodiments. Specifically, it may be possible to move the cursor or the like element on a page displayed on the screen of the image display section in response to a movement of an electronic device after the frame is scrolled or the on-screen page is changed over by manipulation of a key or the like element.

It may be possible to apply this cursor moving and shifting technology to the mobile phone and the digital camera but also to other electronic devices such as a game machine, a personal digital assistant (PDA), and a mobile communications device such as a mobile computer.

Display pages are not limited to the one on which items or menu are displayed in the form of a table, but includes the one on which plural photos or pictures are displayed, so that a desired photo or picture is selected by the cursor.

Specifically, the cursor moving technique as disclosed in the foregoing embodiments is applicable to a PDA constructed such that an image of a desk on which plural stationery supplies are arranged is displayed on a page, selecting an image of a notebook among the stationery supplies with a cursor enables to open the notebook, selecting an image of a clock with the cursor enables to display the date and/or time, and selecting an image of a calendar with the cursor enables to open the schedule, for instance.

Further, this cursor moving and shifting technology is applicable to an arrangement of displaying an image of a shop on a page in an electronic dictionary constructed such that plural commodities are displayed in the image of the shop, and selecting a desired commodity with a cursor enables to display a word or phrase indicating the commodity in a foreign language.

Furthermore, this cursor moving and shifting technology is utilized to provide a digital camera with a function of storing literal information, such as comment, note, personal name, photographing date and time, referring to a specific area within a photographed image, and displaying literal information related to the specific area at a predetermined position on a display when reproducing the photographed image on the screen. The cursor is moved to a given position of a selection menu page to select a desired photographed image or the specific area of the reproduced photographed image to display the literal information on the photographed image.

In the foregoing embodiments, the display of the menu page on the screen of the image display section 5 is terminated based on the judgment that the designated item corresponding to the display position of the cursor CSL1 has been determined in response to depressing of the execution key 7. Alternatively, it may be possible to display a page showing sub items belonging to the upper category in response to depressing of the execution key 7.

Furthermore, it may be possible to construct the mobile phone 1 in such a manner that moving the electronic device such as the mobile phone 1 backward in a direction normal to the displaying surface of the image display section 5 enables to reduce the size of the items to be displayed on the screen of the image display section 5, so that a greater number of items may be displayable on the screen of the image display section 5, and moving the electronic device such as the mobile phone 1 in a forward direction opposite to the backward direction enables to increase the size of the items to be displayed on the screen of the image display section 5, so that a less number of items may be displayable on the screen of the image display section.

As described above, the electronic device has a display capable of displaying a pointing representation, a detector for detecting a movement of the electronic device, and a display controller for controlling the display so as to move the pointing representation displayed on the display in response to the movement of the electronic device detected by the detector.

The above described method for displaying a pointing representation on a display provided in an electronic device, comprises the steps of displaying a pointing representation on the display, detecting a movement of the electronic device, and moving the pointing representation in response to the detected movement of the electronic device.

With the construction, the pointing representation is moved relative to the image displayed on the display in response to the movement of the electronic device detected by the detector. Accordingly, the pointing representation can be moved or shifted to a desired position on the display by controlledly moving the electronic device. Consequently, an aimed item among plural items displayed on the display can be easily selected. Also, there is no need of increasing the number of switches or keys for selecting items even if the number of items is increased.

The pointing representation may preferably moved in a direction identical or opposite to the direction of the detected movement. This movement of the pointing representation will make the user to easily perceive the movement of the pointing representation because of the geometrical correspondence with respect to the movement of the electronic device.

A movement of the electronic device may be preferably detected along a displaying surface of the display. Also, movements of the electronic device may be preferably detected along two axes perpendicular to each other. Further, a movement of the electronic device may be preferably detected in a direction perpendicular to the displaying surface of the display. These movements of the pointing representation are be placed in coordinates corresponding to the movement of the electronic device, so that the user can intuitively perceive the movement direction of the pointing representation.

The pointing representation may be preferably displayed with a plurality of items for indicating one of the items, and moved in response to the detected movement along the displaying surface for selecting one of the items, and the selected item being determined in response to the detected movement perpendicular to the displaying surface. This construction can provide more easily selection of a target item among the plurality of items.

Alternatively, it may be preferable to detect a rotary movement of the electronic device around a predetermined axis. The pointing representation may be preferably moved tangential to the detected rotary movement along a displaying surface of the display. These movement relationships can provide the user with easier manipulation in a reduced space.

Further, a movement of the electronic device in a first direction may be preferably detected to move the pointing representation, and a movement of the electronic device in a second direction may be preferably detected to determine the position designated by the pointing representation. The second direction may be preferably perpendicular to a displaying surface of the display. This construction can provide more easily selection of a target item among the plurality of items.

The pointing representation may be preferably a pointer for designating a displayed icon on the display.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An electronic device comprising:
a display capable of displaying a pointing representation;
a detector for detecting a movement of the electronic device; and
a display controller for controlling the display so as to move the pointing representation displayed on the display in response to the movement of the electronic device detected by the detector.

2. An electronic device according to claim 1,
wherein the pointing representation is moved in a direction identical or opposite to the direction of the detected movement.

3. An electronic device according to claim 1,
wherein the detector detects a movement of the electronic device along a displaying surface of the display.

4. An electronic device according to claim 3,
wherein the detector detects movements of the electronic device along two axes perpendicular to each other.

5. An electronic device according to claim 4,
wherein the detector further detects a movement of the electronic device in a direction perpendicular to the displaying surface of the display.

6. An electronic device according to claim 5,
wherein the pointing representation is displayed with a plurality of items for indicating one of the items, and
wherein the pointing representation is moved in response to the detected movement along the displaying surface for selecting one of the items, and the selected item is determined in response to the detected movement perpendicular to the displaying surface.

7. An electronic device according to claim 1,
wherein the detector detects a rotary movement of the electronic device around a predetermined axis.

8. An electronic device according to claim 7,
wherein the pointing representation is moved tangential to the detected rotary movement along a displaying surface of the display.

9. An electronic device according to claim 1,
wherein the detector detects a movement of the electronic device in a first direction for moving the pointing representation, and detects a movement of the electronic device in a second direction for determining the position designated by the pointing representation.

10. An electronic device according to claim 9,
wherein the second direction is perpendicular to a displaying surface of the display.

11. An electronic device according to claim 1,
wherein the pointing representation is a pointer for designating a displayed icon on the display.

12. A method for displaying a pointing representation on a display provided in an electronic device, the method comprising:
displaying a pointing representation on the display;
detecting a movement of the electronic device; and
moving the pointing representation in response to the detected movement of the electronic device.

13. A method according to claim 12,
wherein the pointing representation is moved in a direction identical or opposite to the direction of the detected movement.

14. A method according to claim 12,
wherein a movement of the electronic device along a displaying surface of the display is detected.

15. A method according to claim 14,
wherein movements of the electronic device along two axes perpendicular to each other are detected.

16. A method according to claim 15, further comprising detecting a movement of the electronic device in a direction perpendicular to the displaying surface of the display.

17. A method according to claim 16, further comprising displaying a plurality of items with the pointing representation,
wherein the pointing representation is moved in response to the detected movement along the displaying surface for selecting one of the items, and the selected item is determined in response to the detected movement perpendicular to the displaying surface.

18. A method according to claim 12,
wherein a rotary movement of the electronic device around a predetermined axis is detected.

19. A pointing representation displaying method according to claim 18,
wherein the pointing representation is moved tangential to the detected rotary movement along a displaying surface of the display.

20. A method according to claim 12,
wherein the movement detection is carried out in a first direction for moving the pointing representation and in a second direction for determining the position designated by the pointing representation.
